(19) United States
(12) Patent Application Publication
(10) Pub. No.: US 2019/0264714 A1
(43) Pub. Date: Aug. 29, 2019

(54) ELECTRO-HYDRAULIC VALVE ACTUATOR HAVING MODULAR MANIFOLD WITH CONFIGURABLE REDUNDANCY

(71) Applicant: Cowan Dynamics Inc., Montréal (CA)

(72) Inventors: Daniel Gagné, Montréal (CA); René Wenker, Beaconsfield (CA)

(21) Appl. No.: 15/907,971

(22) Filed: Feb. 28, 2018

(51) Int. Cl. F15B 20/00; F15B 1/02; F16K 15/18; F16K 31/06

(52) U.S. Cl. CPC F15B 20/002; F15B 1/022; F15B 20/008; F16K 15/186; F16K 31/0651; F15B 2211/8752; F15B 2211/255; F15B 2211/3056; F15B 2211/327; F15B 2211/625; F15B 2211/863; F15B 2211/20515

(57) ABSTRACT

An electro-hydraulic valve actuator having a modular manifold assembly with a network of channels that fluidly connect a hydraulic cylinder assembly to a hydraulic power assembly. The hydraulic cylinder assembly includes a piston rod that can directly or indirectly open or close a process valve. The hydraulic power assembly has a main pump and motor, and the manifold assembly includes a main manifold block to which is mounted the hydraulic cylinder assembly and the main pump and motor. The main manifold block has pluggable channel ports that can be unplugged to provide fluid communication with corresponding channel ports of at least one auxiliary manifold block that can be mounted to and integrated with the main manifold block. The at least one auxiliary manifold block has either a second pump and motor or a manual override pump.

### FIELD

The present subject-matter relates to electro-hydraulic actuators such as are used to control process valves.

### INTRODUCTION

The flow of fluids and other substances carried in process transport pipes is typically controlled using process valves. It may be necessary in an industrial process to close or open a valve in response to specific conditions of the flow and/or the environment, such as a detected change in flow rate, pressure, temperature, and so forth.

Conventional control systems for valve actuators are often designed to respond to changes in process flow in different modes, such as fail open, fail close and fail last (or fail last locked).

Electro-hydraulic actuators are often used in remote field locations where installing and maintaining a hydraulic network that can power multiple valve actuators is not practical. Conventional electro-hydraulic units are often bulky, complex, fragile, and time consuming to install and maintain. They include a hydraulic cylinder with a piston whose piston rod connects via an arm to open and close the process valve; a separate hydraulic reservoir that communicates with the cylinder via a pipe or hose connection; a hydraulic power unit consisting of an electric motor and a hydraulic pump; and a control system which includes valves that direct the flow of hydraulic fluid so as to raise or lower the piston in the cylinder and thereby control the process valve.

In the case of electro-hydraulic actuators designed to operate in a fail open or fail close mode, a return spring (or a hydraulic accumulator) is included to bias the actuator to its failsafe position, usually either to fully open the process valve or fully close it.

In addition to having a failsafe mode, it may be desirable for electro-hydraulic actuators in some installations to be equipped with hydraulic power redundancy, that is, a back-up pump for use in the event that the main pump ceases to be operational. The back-up pump could be a manually-operated pump, or it could be a motorized pump, preferably having an independent electric motor. Providing such operational redundancy further complicates the configuration of conventional electro-hydraulic valve actuators, and makes it very difficult to retrofit existing installations to add operational redundancy.

### SUMMARY

The following summary is intended to introduce the reader to the more detailed description that follows, and not to define or limit the claimed subject matter.

According to a first aspect, the present subject matter provides an electro-hydraulic valve actuator that includes a modular manifold assembly, a hydraulic cylinder assembly, and a hydraulic power assembly. The modular manifold assembly has a network of channels therein. The hydraulic cylinder assembly has a piston with a piston rod that can connect directly or indirectly to open or close a process valve. The hydraulic power assembly has a main pump and motor that is fluidly connected to the hydraulic cylinder assembly by the channels of the manifold assembly. The manifold assembly includes a main manifold block to which is mounted the hydraulic cylinder assembly and the main pump and motor. The main manifold block has pluggable channel ports that can be unplugged to provide fluid communication with corresponding channel ports of at least one auxiliary manifold block mounted to and integrated with the main manifold block.

In some examples, the electro-hydraulic valve actuator comprises at least two auxiliary manifold blocks mounted to and integrated with the main manifold block.

In some examples, the at least one auxiliary manifold block has a second pump and motor.

In some examples, the at least one auxiliary manifold block as a manual override pump.

In some examples, the electro-hydraulic valve actuator further includes a failsafe biasing mechanism for moving the process valve from a normal operating position to a failure mode position.

In some examples, the biasing mechanism includes a return spring.

In some examples, the biasing mechanism includes an accumulator.

According to another aspect, the present subject matter provides a modular manifold assembly for an electro-hydraulic valve actuator having a main pump and motor assembly and having a hydraulic cylinder assembly. The modular manifold assembly includes a main manifold block to which can be mounted the hydraulic cylinder assembly and the main pump and motor assembly. The main manifold block has pluggable channel ports that can be unplugged to provide fluid communication with corresponding channel ports of at least one auxiliary manifold block mounted to and integrated with the main manifold block.

In some examples, the at least one auxiliary manifold block has a second pump and motor mounted to it.

### DRAWINGS

For a better understanding of the subject matter, and to show more clearly how it may be carried into effect, reference will now be made, by way of example, to the accompanying drawings which show exemplary embodiments, and in which:

FIG. 1 shows a perspective view of a modular electro-hydraulic valve actuator.

FIG. 2 is a front elevation view thereof.

FIG. 3 is a side elevation view thereof.

FIG. 4 is a cross-sectional view thereof.

FIG. 5 is a detailed view of the hydraulic cylinder assembly thereof.

FIG. 6 is an isolated perspective view of the manifold assembly thereof.

FIG. 7 is a similar view of the manifold assembly revealing the internal channels of portions of the manifold assembly.

FIG. 8 is a similar perspective view revealing all of the internal channels of the manifold assembly.

FIG. 9 is a schematic view of the hydraulic circuit thereof.

### DESCRIPTION OF VARIOUS EMBODIMENTS

In the following description, specific details are set out to provide examples of the claimed subject matter. However, the embodiments described below are not intended to define or limit the claimed subject matter.

It will be appreciated that, for simplicity and clarity of illustration, where considered appropriate, reference numerals may be repeated among the figures to indicate corresponding or analogous elements or steps. Certain specific details are set forth in order to provide a thorough understanding of the subject matter. However, it will be understood by those of ordinary skill in the art that many details could be varied without departing from the claimed subject matter. Moreover, structures and components that are well known to those skilled in the art have not been described in detail so as not to obscure the present subject matter.

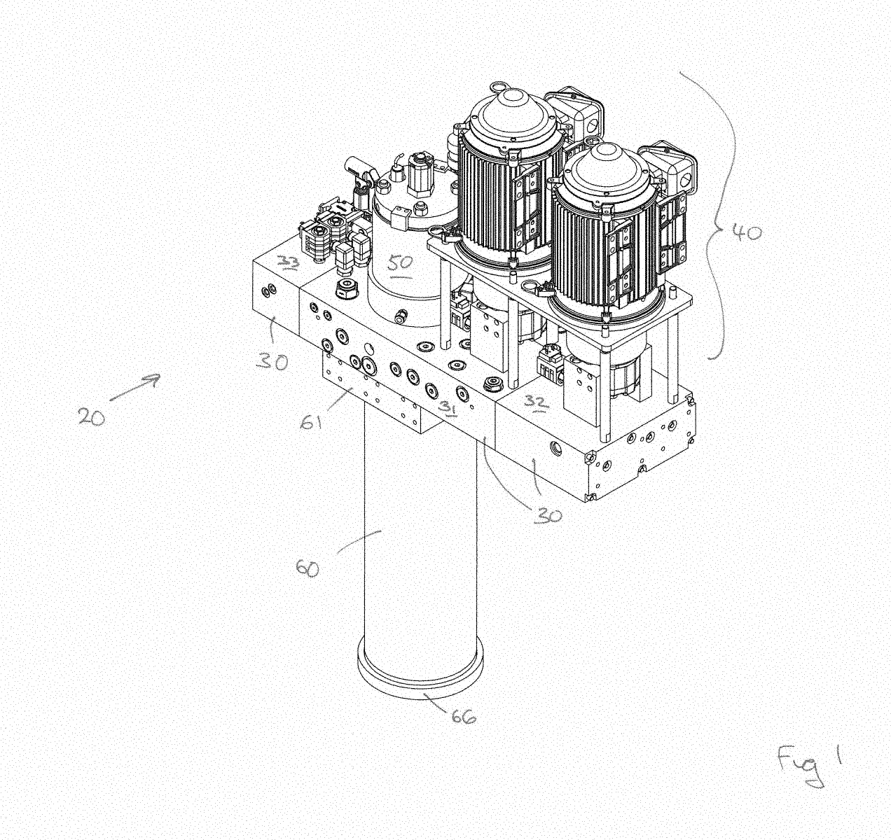

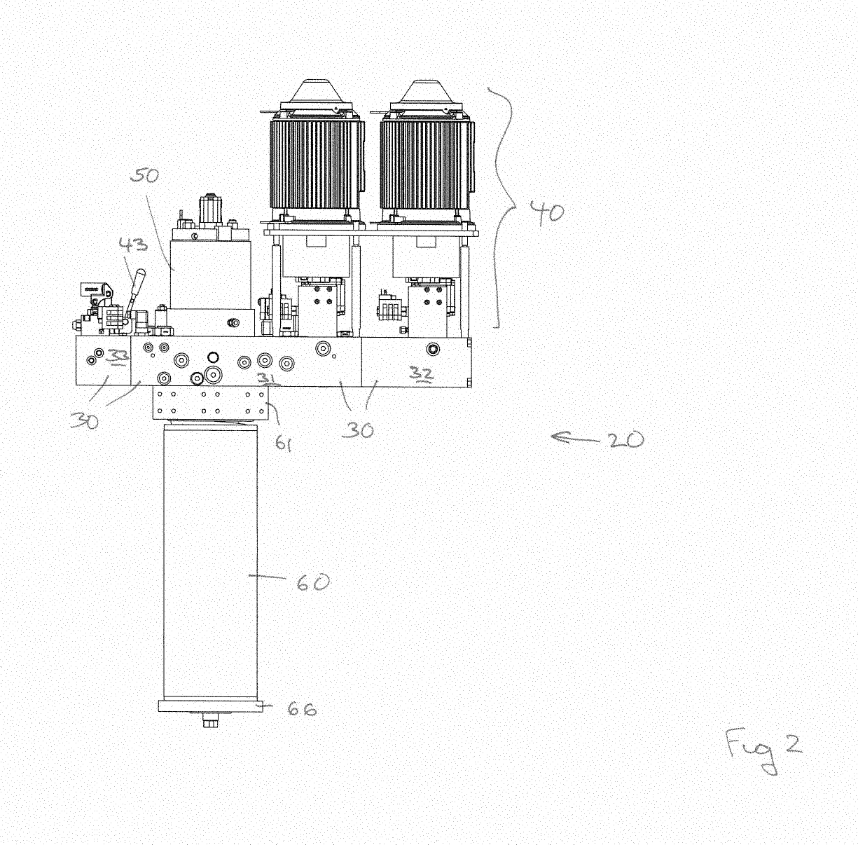

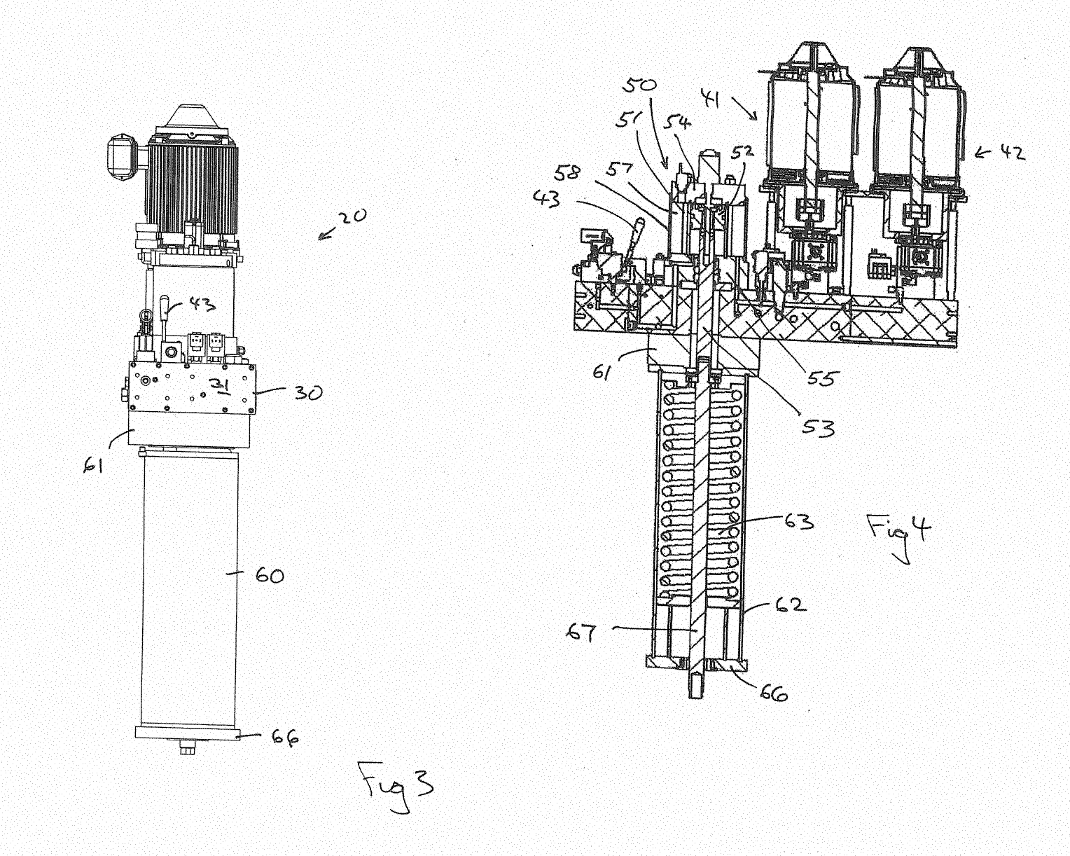

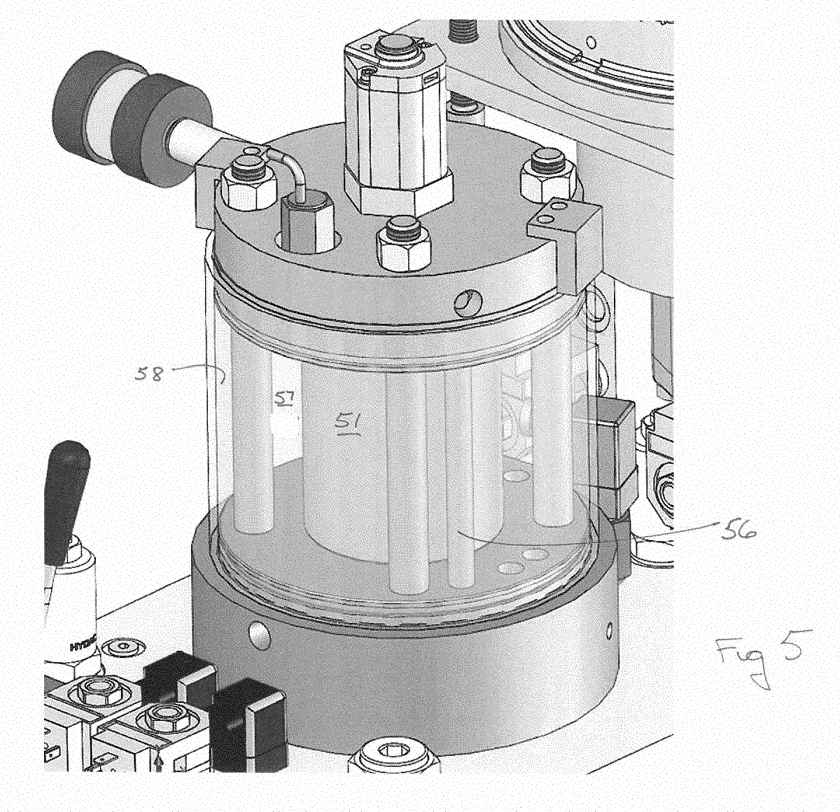

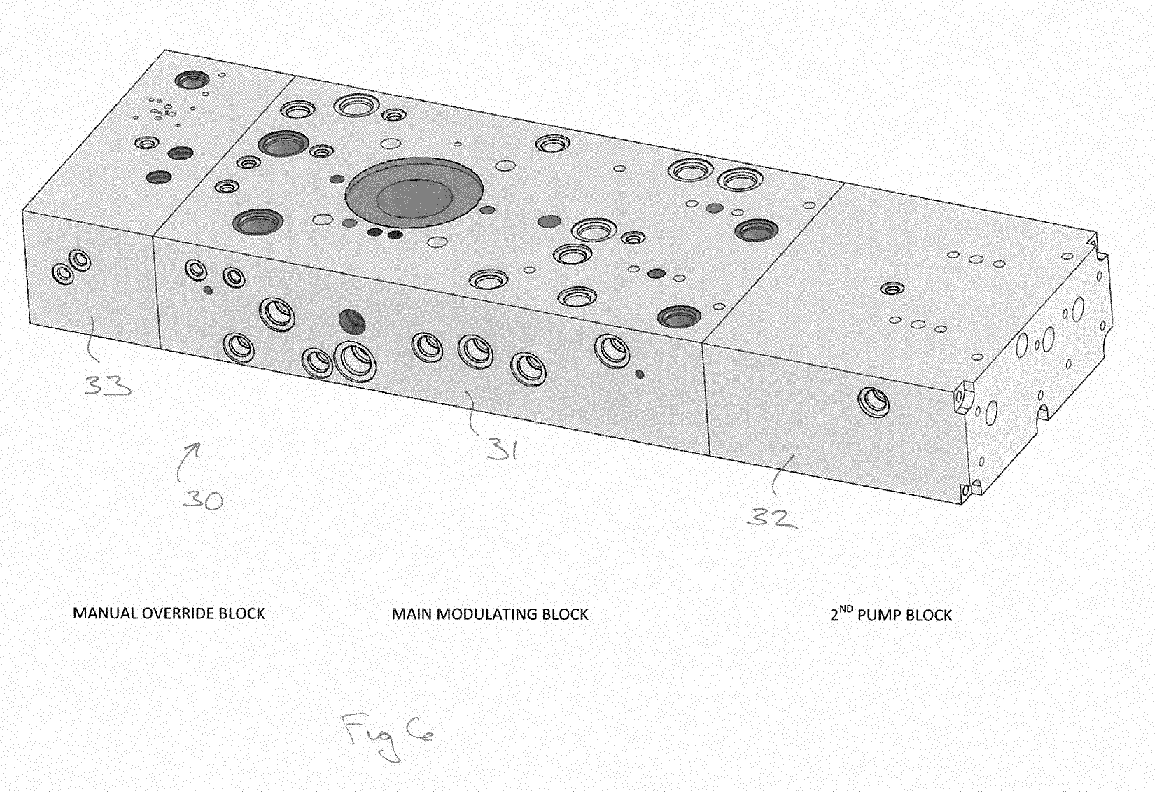

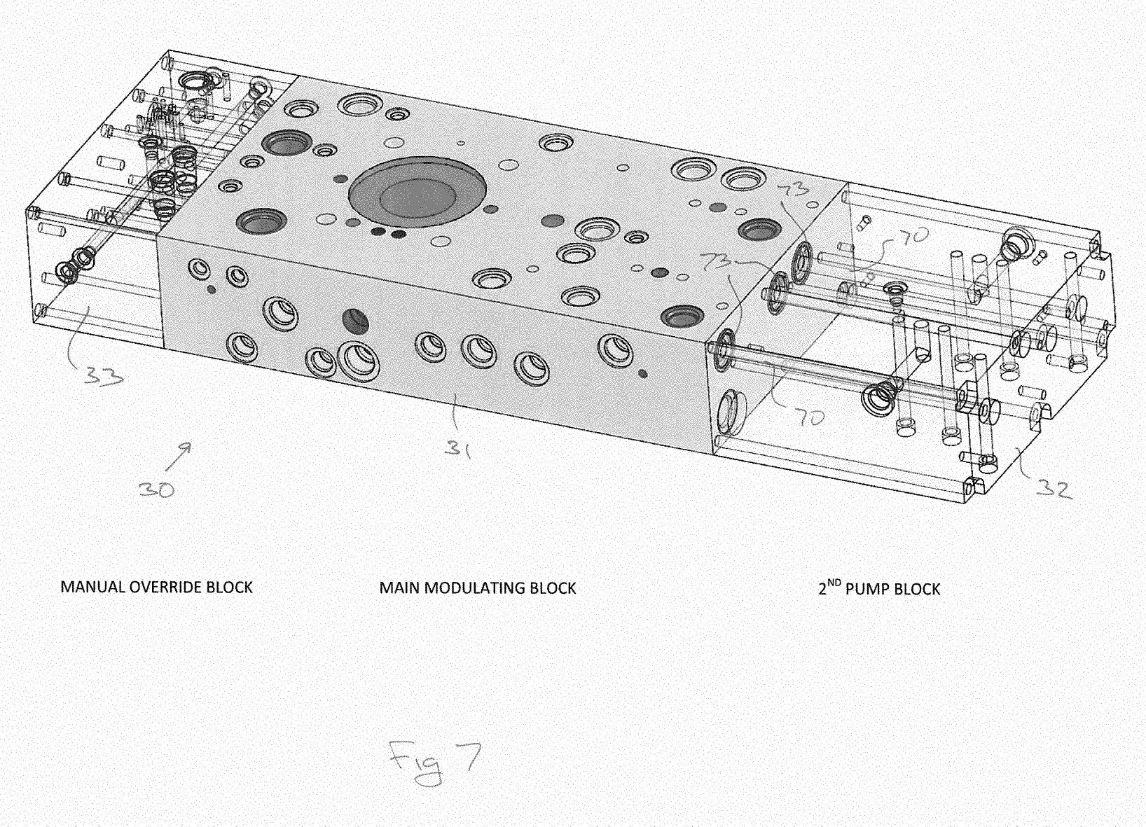

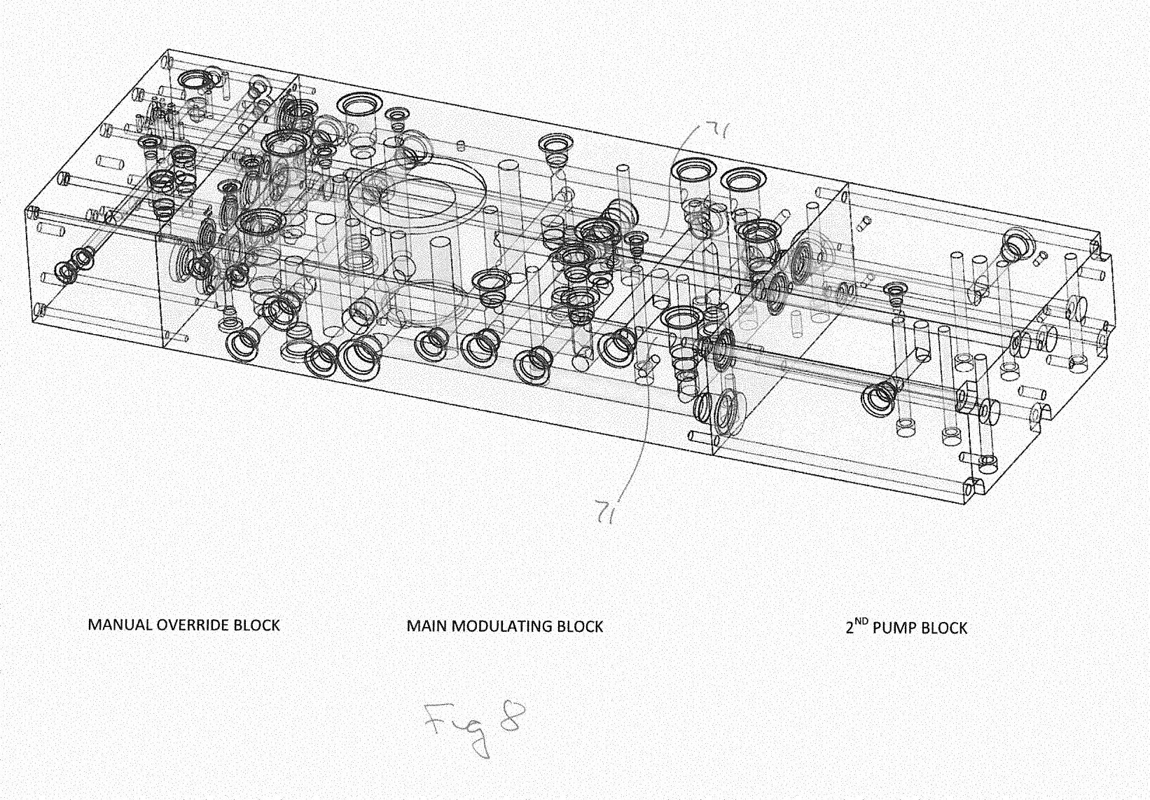

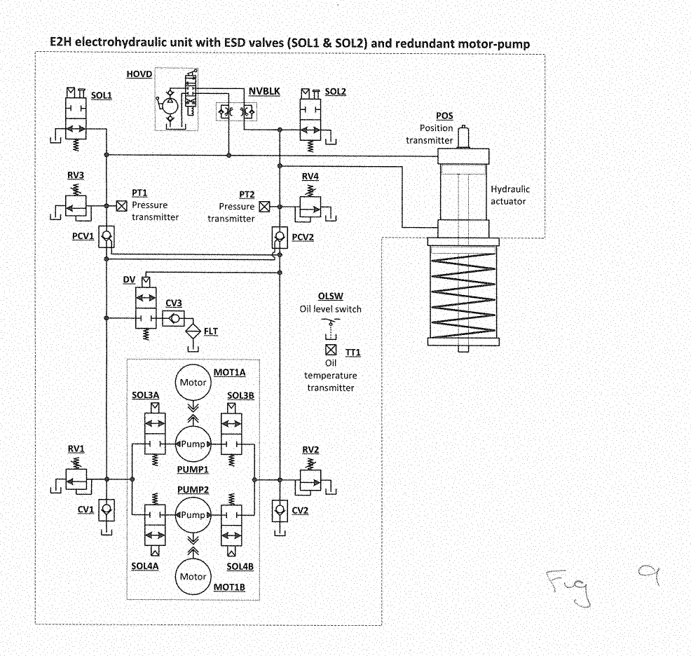

Referring first to FIGS. 1-5 an electro-hydraulic actuator 20 has a modular manifold assembly 30, a hydraulic power assembly 40, a hydraulic cylinder assembly 50 and a return spring assembly 60.

The modular manifold assembly 30 has a main manifold block 31, an integral secondary manifold block 32, and an integral manual override manifold block 33.

The hydraulic cylinder assembly 50 is mounted to the main manifold block 31. The hydraulic cylinder assembly 50 includes a cylinder barrel 51, a piston 52 with a piston rod 53. The cylinder barrel 51 is sealed at its upper end by a cylinder cap 54 and at its lower end by a cylinder head 55 which provides a base by which the hydraulic cylinder assembly 50 is mounted to the main manifold block 31.

The hydraulic power assembly 40 comprises a main pump and motor assembly 41, and a secondary pump and motor assembly 42. The main pump and motor assembly 41 is mounted to the main manifold block 31, whereas the secondary pump and motor assembly 42 is mounted to the secondary manifold block 32.

The hydraulic power assembly 40, also includes a manual override pump 43 which is mounted to the manual override manifold block 33.

The return spring assembly 60 is also mounted to the main manifold block 31 by means of a mounting block 61. The return spring assembly 60 is aligned with, and opposite to, the hydraulic cylinder assembly 50. Assuming that the electro-hydraulic actuator is oriented such that the modular manifold assembly 30 is generally horizontal, the hydraulic cylinder assembly 50 is mounted vertically above the main manifold block 31, whereas the return spring assembly 60 is mounted vertically below the main manifold block 31.

The return spring assembly 60 as a spring canister 62 containing a compression spring 63. The end of the spring canister 62 that is distal from the main manifold block 31 has a mounting plate 66 by which the electro-hydraulic actuator 20 can be mounted to a process valve assembly (not shown). A connecting arm 67 extends from the piston rod 53 through the spring canister 62 and exteriorly of the valve mounting plate 66 so that the connecting arm 67 can be linked directly or indirectly to the valve stem of the process valve (not shown).

The hydraulic cylinder assembly 50 also includes hydraulic supply lines 56, and an annular hydraulic reservoir 57 defined by the outer surface of the cylinder barrel 51 and the inner surface of a concentric reservoir wall 58.

A network of channels 70 within the manifold assembly 30 connects the hydraulic power assembly 40 to the hydraulic cylinder assembly 50.

As shown, the electro-hydraulic actuator 20 is configured for operation in a fail open mode. However, the main manifold channels 71 can be reconfigured with an alternate return spring assembly (not shown) that enables the electro-hydraulic actuator 20 to operate in fail closed mode, or alternatively with no return spring assembly 60 so that the electro-hydraulic actuator 20 operates in fail last mode. (In fail last mode, the solenoid valves SOL1 and SOL2 shown in FIG. 9 are omitted and their connection parts on the manifold assembly 30.)

Certain of the main manifold channels 71 terminate at portals 73 on side faces in of the main manifold block 31. The portals 73 can be plugged, or can be open to provide fluid communication with corresponding aligned portals of channels in mounted integral auxiliary manifold blocks 32, 33.

Turning to the hydraulic circuit diagram of FIG. 9, during normal operation, solenoid valves SOL1 and SOL2 are energized to prevent leakage of the cylinder ports back to the reservoir 57. When the main pump and motor assembly 41 operates, hydraulic pressure is forwarded to the cylinder on the cap side of piston 52 via piloted check valves PCV1 and PCV2. The piloted check valves require that pressure be applied to one to permit opening the other. The hydraulic pressure moves the piston 52 in the direction away from the cap 54 toward the head 55. The piston rod 53 thereby extends and moves the connecting arm 67 so as to close the process valve. At the same time, spring 63 is compressed within the canister 62. When the process valve is fully closed (or in an intermediary position in the case of a modulating actuator), the main pump and motor assembly 41 is turned off. The pressure at the check valves thus drops and they close, maintaining the existing pressure in the cylinder.

In the event of a failure, solenoid valves SOL1 and SOL2 are de-energized and connect both cylinder ports to the reservoir 57. This permits the compressed spring 63 to decompress and move the piston to its retracted position, thereby opening the process valve.

In the event that the main pump and motor assembly 41 become non-operable, the actuator 20 automatically switches to the secondary pump and motor assembly 42. Referring again to the hydraulic circuit of FIG. 9, switching from the main pump and motor assembly 41 to the secondary pump and motor assembly 42 is effected by de-energizing solenoid valves SOL3A and SOL3B to isolate the main pump and motor assembly 41, and energizing solenoid valves SOL4A and SOL4B to select and activate the secondary pump and motor assembly 42.

The manual override pump 43 can be activated by opening needle valves NVBLK, to actuate the manual hand valve HOVD for the appropriate actuator direction (either process valve open or process valve closed), and then operating the manual override pump 43 to generate actuator movement. When a manual override operation has been completed, the needle valves NVBLK are closed to isolate the override circuit from the actuator.

While the above description provides examples of the present subject matter, it will be appreciated by those skilled in the art that certain features and/or functions of the described examples can be modified without departing from the scope of the subject matter as defined in the claims appended hereto.

1. An electro-hydraulic valve actuator comprising:
a) a modular manifold assembly having therein a network of channels;
b) a hydraulic cylinder assembly having a piston with piston rod that can connect directly or indirectly to open or close a process valve;
c) a hydraulic power assembly having a main pump and motor and being fluidly connected to the hydraulic cylinder assembly by the channels of the manifold assembly;
d) wherein the manifold assembly has a main manifold block to which is mounted the hydraulic cylinder assembly and the main pump and motor; and
e) wherein the main manifold block has pluggable channel ports that can be unplugged to provide fluid communication with corresponding channel ports of at least one auxiliary manifold block mounted to and integrated with the main manifold block.

2. The electro-hydraulic valve actuator of claim 1, comprising at least two auxiliary manifold blocks mounted to and integrated with the main manifold block.

3. The electro-hydraulic valve actuator of claim 1, wherein the at least one auxiliary manifold block has a second pump and motor mounted to it.

4. The electro-hydraulic valve actuator of claim 1, wherein at least one auxiliary manifold block as a manual override pump mounted to it.

5. An electro-hydraulic valve actuator of claim 1, further comprising a failsafe biasing mechanism for moving the process valve from a normal operating position to a failure mode position.

6. The electra-hydraulic valve of claim 5, wherein the biasing mechanism includes a return spring.

7. The electro-hydraulic valve of claim 5, wherein the biasing mechanism includes an accumulator.

8. An electro-hydraulic valve actuator of claim 2, further comprising a failsafe biasing mechanism for moving the process valve from a normal operating position to a failure mode position.

9. The electro-hydraulic valve of claim 8, wherein the biasing mechanism includes a return spring.

10. The electro-hydraulic valve of claim 8, wherein the biasing mechanism includes an accumulator.

11. An electro-hydraulic valve actuator of claim 3, further comprising a failsafe biasing mechanism for moving the process valve from a normal operating position to a failure mode position.

12. The electro-hydraulic valve of claim 11, wherein the biasing mechanism includes a return spring.

13. The electro-hydraulic valve of claim 11, wherein the biasing mechanism includes an accumulator.

14. An electro-hydraulic valve actuator of claim 4, further comprising a failsafe biasing mechanism for moving the process valve from a normal operating position to a failure mode position.

15. The electro-hydraulic valve of claim 14, wherein the biasing mechanism includes a return spring.

16. The electro-hydraulic valve of claim 14, wherein the biasing mechanism includes an accumulator.

17. A modular manifold assembly for an electro-hydraulic valve actuator having a main pump and motor assembly and having a hydraulic cylinder assembly, the modular manifold assembly comprising:
a main manifold block to which can be mounted the hydraulic cylinder assembly and the main pump and motor assembly;
wherein the main manifold block has pluggable channel ports that can be unplugged to provide fluid communication with corresponding channel ports of at least one auxiliary manifold block mounted to and integrated with the main manifold block.

18. The modular manifold assembly of claim 17, wherein the at least one auxiliary manifold block has a second pump and motor mounted to it.

19. The modular manifold assembly of claim 17, wherein the at least one auxiliary manifold block has a manual override pump mounted to it.
